(19) United States
(12) Patent Application Publication
(10) Pub. No.: US 2026/0082343 A1
(43) Pub. Date: Mar. 19, 2026

(54) METHODS AND APPARATUS FOR SYNCHRONIZATION SIGNAL BLOCK TRANSMISSION

(71) Applicant: Nokia Technologies Oy, Espoo (FI)

(72) Inventors: Anup TALUKDAR, Naperville, IL (US); Mark CUDAK, Rolling Meadows, IL (US); Kenneth GUSTAFSON, Schaumburg, IL (US); Eugene VISOTSKY, Buffalo Grove, IL (US)

(73) Assignee: Nokia Technologies Oy, Espoo (FI)

(21) Appl. No.: 19/108,549

(22) PCT Filed: Sep. 8, 2022
(86) PCT No.: PCT/US2022/042827

§ 371 Date: Mar. 4, 2025

(51) Int. Cl. H04W 56/00; H04L 5/00

(52) U.S. Cl. CPC H04W 56/002; H04L 5/0007

(57) ABSTRACT

Systems, methods, apparatuses, and computer program products for a NCR transmitting SSBs. One method may include obtaining a synchronization signal block configuration including at least a set of synchronization signal block identifiers, to be transmitted over an access link. The method may further include transmitting at least one synchronization signal block over an access link according to the synchronization signal block configuration.

### TECHNICAL FIELD

Certain example embodiments may generally relate to mobile or wireless telecommunication systems. Some example embodiments may relate in particular to systems, methods, and/or apparatuses for a network controlled repeater (NCR) transmitting synchronization signal blocks (SSBs).

### BACKGROUND

Examples of mobile or wireless telecommunication systems may include radio frequency (RF) fifth-generation technology standard for broadband cellular networks (5G) radio access technology (RAT), the Universal Mobile Telecommunications System (UMTS) Terrestrial Radio Access Network (UTRAN), LTE Evolved UTRAN (E-UTRAN), LTE-Advanced (LTE-A), LTE-A Pro, new radio (NR) access technology, and/or 5G beyond. NR is targeting to deliver extreme broadband, ultra-robust, low-latency connectivity, and massive networking to support the Internet of Things (IoT).

5G standard is now considering NCRs to further improve coverage, but with limited cost of the NCR. The NCR may be referred to as a repeater in the current disclosure.

### SUMMARY

In accordance with certain example embodiments, an apparatus may include at least one transceiver and at least one processor coupled to the at least one transceiver. The apparatus may be configured to at least obtain a SSB configuration including at least a set of SSB identifiers to be transmitted over an access link. The apparatus may be further configured to transmit at least one SSB over the access link according to the SSB configuration.

In accordance with various example embodiments, a method may include obtaining a SSB configuration including at least a set of SSB identifiers to be transmitted over an access link. The method may further include transmitting at least one SSB over the access link according to the SSB configuration.

In accordance with certain example embodiments, an apparatus may include means for obtaining a SSB configuration including at least a set of SSB identifiers to be transmitted over an access link. The apparatus may further include means for transmitting at least one SSB over the access link according to the SSB configuration.

In accordance with some example embodiments, a non-transitory computer readable medium may include program instructions that, when executed by an apparatus, cause the apparatus to perform at least a method. The method may include obtaining a SSB configuration including at least a set of SSB identifiers to be transmitted over an access link. The method may further include transmitting at least one SSB over the access link according to the SSB configuration.

In accordance with various example embodiments, a computer program product may perform a method. The method may include obtaining a SSB configuration including at least a set of SSB identifiers to be transmitted over an access link. The method may further include transmitting at least one SSB over the access link according to the SSB configuration.

In accordance with certain example embodiments, an apparatus may include at least one processor and at least one memory storing instructions that, when executed by the at least one processor, cause the apparatus at least to obtain a SSB configuration including at least a set of SSB identifiers to be transmitted over an access link. The at least one memory and instructions, when executed by the at least one processor, may further cause the apparatus at least to transmit at least one SSB over the access link according to the SSB configuration.

In accordance with some example embodiments, an apparatus may include obtaining circuitry configured to obtain a SSB configuration including at least a set of SSB identifiers to be transmitted over an access link. The apparatus may further include transmitting circuitry configured to transmit at least one SSB over the access link according to the SSB configuration.

In accordance with certain example embodiments, an apparatus may include at least one transceiver and at least one processor coupled to the at least one transceiver. The apparatus may be configured to at least obtain a SSB configuration. The SSB configuration may include at least a set of SSB identifiers to be transmitted over an access link of a repeater. The apparatus may be further configured to transmit, to the repeater, the SSB configuration.

In accordance with various example embodiments, a method may include obtaining a SSB configuration. The SSB configuration may include at least a set of SSB identifiers to be transmitted over an access link of a repeater. The method may further include transmitting, to the repeater, the SSB configuration.

In accordance with certain example embodiments, an apparatus may include means for obtaining a SSB configuration. The SSB configuration may include at least a set of SSB identifiers to be transmitted over an access link of a repeater. The apparatus may further include means for transmitting, to the repeater, the SSB configuration.

In accordance with some example embodiments, a non-transitory computer readable medium may include program instructions that, when executed by an apparatus, cause the apparatus to perform at least a method. The method may include obtaining a SSB configuration. The SSB configuration may include at least a set of SSB identifiers to be transmitted over an access link of a repeater. The method may further include transmitting, to the repeater, the SSB configuration.

In accordance with various example embodiments, a computer program product may perform a method. The method may include obtaining a SSB configuration. The SSB configuration may include at least a set of SSB identifiers to be transmitted over an access link of a repeater. The method may further include transmitting, to the repeater, the SSB configuration.

In accordance with certain example embodiments, an apparatus may include at least one processor and at least one memory storing instructions that, when executed by the at least one processor, cause the apparatus at least to obtain a SSB configuration. The SSB configuration may include at least a set of SSB identifiers to be transmitted over an access link of a repeater. The at least one memory and instructions, when executed by the at least one processor, may further cause the apparatus at least to transmit, to the repeater, the SSB configuration.

In accordance with some example embodiments, an apparatus may include obtaining circuitry configured to obtain a SSB configuration. The SSB configuration may include at least a set of SSB identifiers to be transmitted over an access link of a repeater. The apparatus may further include transmitting circuitry configured to transmit, to the repeater, the SSB configuration.

### BRIEF DESCRIPTION OF THE DRAWINGS

For a proper understanding of various example embodiments, reference should be made to the accompanying drawings, wherein:

FIG. 1 illustrates an example of a topological architecture of a NR deployment with a repeater.

FIG. 2 illustrates an example of a signaling diagram according to certain example embodiments.

FIG. 3 illustrates an example of a deployment scenario according to some example embodiments.

FIG. 4 illustrates an example of another deployment scenario according to various example embodiments.

FIG. 5 illustrates an example of another deployment scenario according to certain example embodiments.

FIG. 6 illustrates an example of a flow diagram of a method according to some example embodiments.

FIG. 7 illustrates an example of a flow diagram of another method according to various example embodiments.

FIG. 8 illustrates an example of various network devices according to certain example embodiments.

### DETAILED DESCRIPTION

It will be readily understood that the components of some example embodiments, as generally described and illustrated in the figures herein, may be arranged and designed in a wide variety of different configurations. Thus, the following detailed description of various example embodiments of systems, methods, apparatuses, and computer program products for a NCR transmitting SSBs is not intended to limit the scope of certain example embodiments, but is instead representative of selected example embodiments.

3rd Generation Partnership Project (3GPP) Release (Rel)-16 and 17 of 5G NR includes some deployments for lower frequency bands (i.e., below 6 GHz) and higher frequency bands (i.e., 23 GHZ). Propagation characteristics in deployments at these higher frequencies may become more challenging compared to deployments at lower frequencies. In particular, the higher path loss and attenuation in the reflected and diffraction paths at these higher frequencies may require densification of the network, necessitating a larger number of cell sites and/or use of beamforming techniques to achieve the desired link budget.

However, providing connectivity to all of the cells in such a dense deployment scenario may not be possible due to unavailability of wired backhauls and/or the high cost of deploying a wired backhaul (BH) network.

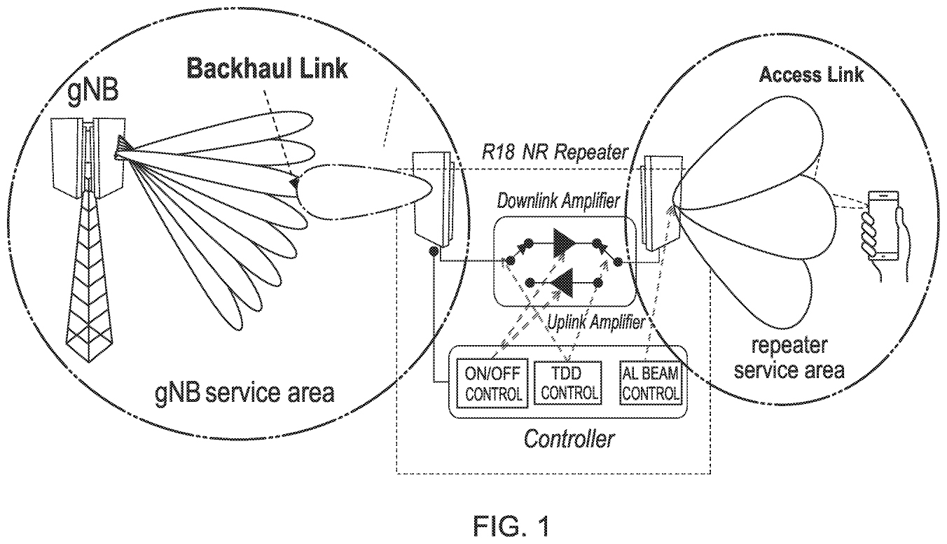

Currently, 3GPP specifies some RF and electromagnetic compatibility (EMC) requirements for RF repeaters, such as those in the topological NR deployment architecture shown in FIG. 1. These repeaters can include low-cost relay devices that amplify and forward received signals. However, these RF repeaters may have limited benefits in systems using beamformed links, particularly in the high frequency bands of NR. Therefore, a repeater with adaptive access-link beamforming, ON-OFF controls, and semi-static and/or dynamic time division duplex (TDD) (e.g., NCR) may provide some solutions.

With adaptive beamforming capabilities, a repeater may receive downlink signals from a base station (e.g., gNB) over its backhaul (BH) link beam, and then relay the signal over one or more access links through one or more beams. The base station may be referred to herein as a donor base station. Similarly, the repeater may receive signals from one or more user devices over one or more access links, and then relay the signals over its BH link beam to the donor base station. The one or more access link beams used to transmit or receive signals to/from one or more user devices may be configured before the transmission/reception.

As used herein, “user device” may refer to user equipment (UE) and/or a user terminal. Similarly, “access link” may refer to one or more links used to communicate with at least one user device. An access link may communicate with at least one user device over at least one beam.

In some example embodiments, a user device may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, a user device may be one or more of a citizens broadband radio service device (CBSD).

As used herein, the term “beam” may refer to a communication resource. Different beams may be considered as different resources. A beam may also be represented as a spatial filter. A technology for forming a beam may be a beamforming technology or another technology. The beamforming technology may be specifically a digital beamforming technology, analog beamforming technology, or a hybrid digital/analog beamforming technology. A communication device (including the terminal device and the network device) may communicate with another communication device through one or more beams. One beam may include one or more antenna ports and be configured for a data channel, a control channel, or the like. One or more antenna ports forming one beam may also be considered as an antenna port set. A beam may be configured with a set of resource, or a set of resource for measurement.

The donor base station may have a limited number of SSB IDs in a SSB ID space it uses, and the beam of a corresponding SSB ID can provide coverage of a service area covered by the beam, as well as the service areas of its repeaters related to the beam. Each SSB transmission may have overhead (e.g., 4 symbols), and may be associated with a SSB ID. There may also be radio resource requirements for transmissions of system information block (SIB) and for physical random access channel (PRACH) occasions. Additionally, each SSB may have some overhead for configuring corresponding SIB. In certain deployment scenarios (e.g., outdoor-to-indoor coverage extensions), a significant number of SSB beams may be supported by a repeater, but the repeater may detect only one SSB from a (donor) base station. From the point of view of an access link, it may be difficult to differentiate different SSBs of the access link when the repeater can only detect a limited number of backhaul link/beams, as well as avoiding interference of the access beams.

Various example embodiments described herein may have various benefits and/or advantages to overcome the disadvantages described above. For example, certain example embodiments may reuse the SSB ID of the backhaul link over access link of the repeater. This can provide the advantage that only a limited number SSB IDs are needed. Some example embodiments may also avoid interference of SSB between backhaul link and access link of the repeaters through SSB configuration to different repeaters. Thus, various example embodiments discussed below are directed to improvements in computer-related technology to support NCRs/repeaters in a wireless communication system.

Certain example embodiments discussed below may relate to the transmission of synchronization signals (SS) in NR, and more specifically, using a limited set of SSBs to provide coverage of a cell expanded by repeaters. For example, a base station may transmit SSs in a SSB over a directional beam. The repeater may repeat/relay the SSB transmission over multiple directional beams to provide coverage to the coverage of the repeater, wherein each SSB may be identified by a unique SSB ID (e.g., SSB_id). A repeater deployed to extend the coverage of a donor base station may relay the SSB signals received from the donor base station over its access link beams and vice versa to extend its service area.

Some example embodiments may enable a donor base station (e.g., gNB) to provide coverage to a service area of a repeater by reusing a subset of the SSB IDs that had been used to provide coverage to its own service area and/or the service area of another repeater. The SSB corresponding to the reused SSB IDs may be replicated from different or the same antenna panels of the donor base station. For the panel providing the BH links to the repeater, these SSBs may be transmitted over the BH beam to the repeater, and the repeater may then relay or regenerate SSBs over its access link beams to provide coverage to its service area.

Thus, various example embodiments discussed below may include a base station reusing SSB IDs among the service areas of the base station and the service areas of the repeaters of the base station.

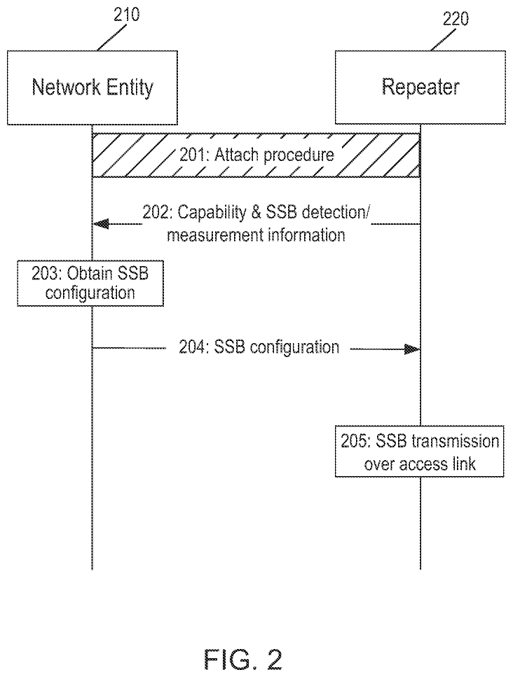

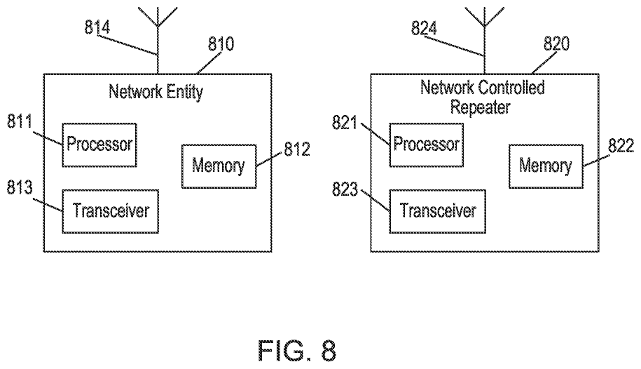

FIG. 2 illustrates an example of a signaling diagram depicting reusing a subset of SSB IDs. NE 210 and repeater 220 may be similar to NE 810 and NCR 820, respectively, as illustrated in FIG. 8, according to certain example embodiments.

At 201, repeater 220 may initiate an attach procedure to NE 210. At 202, repeater 220 may transmit to NE 210 capability and/or SSB detection/measurement information of repeater 220. The transmitted capabilities of repeater 220 may indicate at least one of: a number of beams that can be supported in an access link; a number of supported analog beams; a number of supported digital beams; a number of supported bandwidth part (BWP); and/or supported bandwidth. As an example, the SSB detection/measurement information may include at least one of: SSB-RSRP measured by repeater 220; and detected beams with a quality above and/or below a threshold. Specifically, beams with a quality above the threshold may not be candidates for reuse, while beams with quality below the threshold may be candidates for reuse. The SSB detection/measurement information may also include an indication of a number of SSB beams (and associated beam IDs) that repeater 220 detected/measured.

At 203, NE 210 may obtain a SSB configuration, and at 204, NE 210 may transmit the SSB configuration to repeater 220. Obtaining the SSB configuration may be based on the capability and/or SSB detection/measurement information received from repeater 220 at 202. The SSB configuration may include at least a set of SSB IDs to be transmitted over an access link of a repeater. In particular, NE 210 may obtain SSB IDs for repeater 220 based upon the SSB configuration for other repeaters controlled by NE 210. For example, NE 210 may consider the SSB ID configured or reported by other repeaters which near repeater 220 for obtaining the SSB configuration for repeater 220. NE 210 may obtain the SSB configuration to avoid overlapping between the SSB IDs of the other repeaters in order to avoid interference among repeaters.

In some example embodiments, the SSB configuration may include at least a set of time-frequency resource allocation information. Furthermore, in various example embodiments, the SSB configuration may include at least one set of information configured to generate at least one primary synchronization signal (PSS); information configured to generate at least one secondary synchronization signal (SSS); physical broadcast channel (PBCH); at least one SSB sequence; at least one ID of a repeater configured to transmit the at least one SSB; a time and/or duration associated with transmitting the at least one SSB; at least one BW ID; and at least one BWP. The SSB IDs of the at least a set of SSB IDs may differ from at least a set of other SSB IDs measured by repeater 220, respectively.

In certain example embodiments, NE 210 may determine which SSB IDs may be reused. For example, the SSB IDs may be used by NE 210 over one or more panels. At least one of these panels may provide a BH link to repeater 220. NE 210 may transmit to repeater 220 time-frequency resources for the transmission of selected SSBs as per its SSB broadcast schedule. NE 210 may transmit the SSBs with IDs from the multiple selected panels which serve repeater 220. NE 210 may also include time-frequency resources in the SSB configuration for the PRACH occasions corresponding to the selected SSBs. Multiple SSBs may share the same PRACH occasions. For each selected SSB ID, NE 210 may listen on the corresponding PRACH occasion for RACH preambles.

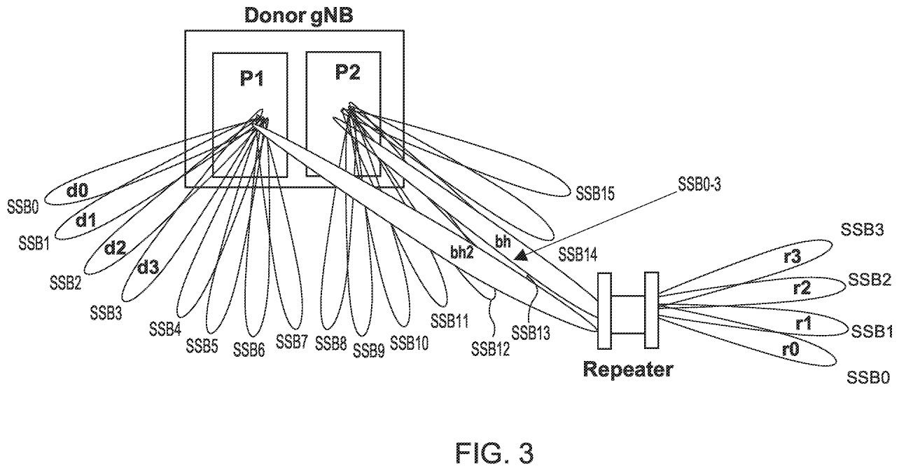

In some example embodiments, different panels of NE 210 may transmit SSBs to a same or different repeater 220. As shown in FIG. 3, a donor gNB (e.g., NE 210) may transmit the SSBs with SSB IDs SSB₀-SSB₃ from antenna panel P₁ to cover the service area of the donor gNB over its beams d₀, d₁, d₂, and d₃, respectively. Simultaneously, antenna panel P₂ of the donor gNB may configure the SSBs with SSB IDs SSB₀-SSB₃ over BH link bh₂ to the repeater (e.g., repeater 220). The repeater may then transmit the SSBs with SSB IDs SSB₀-SSB₃ over its access link r₀, r₁, r₂, and r₃, respectively, as discussed below.

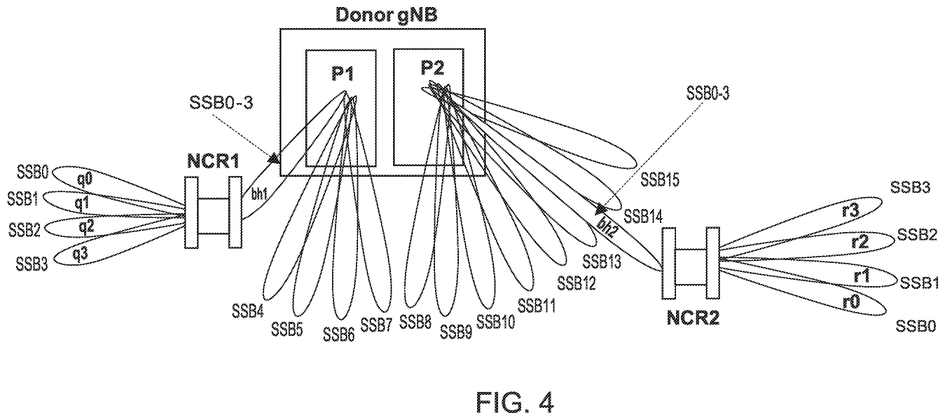

In another example, NE 210 may control two repeaters (similar to repeater 220) which reuse SSB IDs SSB₀-SSB₃ of NE 210. Specifically, FIG. 4 depicts a donor gNB (e.g., NE 210) transmitting the SSBs with IDs SSB₀-SSB₃ from both antenna panels P₁ and P₂ over the BH beams bh₁ and bh₂, to its repeaters NCR₁ and NCR₂ (e.g., repeater 220), respectively. The two repeaters may transmit those SSBs over their access link, with beams q₀-q₃ of NCR₁ and r₀-r₃ of NCR₂, to provide coverage to their respective service areas.

In an example, NE 210 may support multiple BWPs, and some BWPs may support SSB transmission. NE 210 may indicate at least one BWP ID associated with a set of SSB IDs, such as the set of SSB IDs that may be reused for the associated BWP ID. If only one BWP is supported by repeater 220, the SSB configuration may only include the SSB IDs to be reused of a default BWP of NE 210. In a scenario with multiple BWPs, the SSB configuration may include at least two set of SSB IDs, and each set of SSB IDs may correspond with one BWP identified by the BWP ID.

In various example embodiments, the SSB configuration may further include at least a set of time-frequency resources allocated for the SSB transmission over the access link of repeater 220. In particular, the time-frequency resources may be needed when SSB can be transmitted over multiple BWPs.

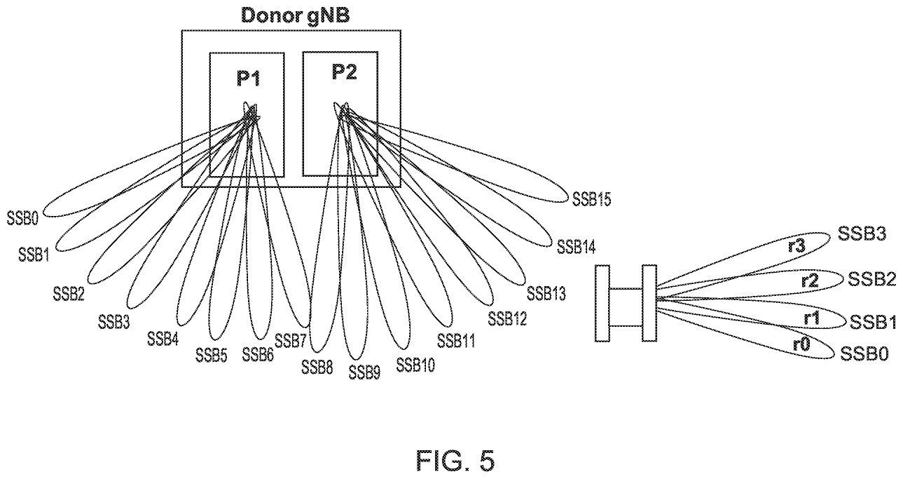

In a further example, NE 210 may configure SSB IDs for repeater 220, which may then be used to generate the SSBs by repeater 220. As shown in FIG. 5, a donor gNB (e.g., NE 210) may configure SSB IDs to its repeaters (e.g., repeater 220), similar to that performed in FIG. 3 and FIG. 4 above to allow reuse of SSB IDs. However, instead of the donor gNB transmitting the SSBs over the BH beams to the repeater, the repeater itself may generate the SSBs using the IDs shown in FIG. 5. SSBs generated by the repeater may be based on a standard definition in 3GPP technical specification 38.213 for SSB symbol indexes according to different frequencies. This scheme may provide energy savings and reduce unnecessary donor link transmissions.

In order for repeater 220 to generate and transmit the SSB signals, the repeater may require PSS and SSS; PBCH demodulation reference signal (DMRS) and PBCH data; and SSB schedules. Repeater 220 may acquire any of this information from NE 210 from the SSB configuration. In certain example embodiments, the SSB IDs for repeater 220 may be configured by NE 210 based on the capabilities and detected/measured information transmitted by repeater 220. From the point of view of repeater 220, repeater 220 may receive the SSB configuration from NE 210, as described above.

In some example embodiments, various types of SSB configurations may be possible. In various example embodiments, SSB configurations may be persistent, wherein repetitive signals such as SSB, CSI-RS, and SI can be relayed without requiring a per-transmission control signal. Once configured with a persistent relay schedule, downlink (DL) and/or uplink (UL) transmissions may be relayed without additional signaling from NE 210 to repeater 220.

In certain example embodiments, repeater 220 may be configured with one or more QCL-RNTI values that permit NE 210 to utilize special DCI transmissions for dynamic control for dynamic control of relay. Each QCL-RNTI may be used to control relaying in either a unidirectional or bidirectional fashion. As used herein, QCL may refer to different transmissions of SSB over the access link beam (e.g., a set of related precoding and/or beamforming weights used over the access link). For example, repeater 220 may transmit one or more beams to different areas/coverages over an access link according to the SSB configuration received at step 204.

In some example embodiments, repeater 220 can be configured to generate repetitive signals such as SSB, CSI-RS, and SI broadcasts. This may eliminate the need for NE 210 to transmit such signals, and may allow donor cell resources to be used for other transmissions.

In various example embodiments, the SSB configuration may include SSB ID, periodicity and offset, duration (e.g., symbols), and QCL identification. The QCL identification may be used to indicate the transmission direction. The QCL may be reported by repeater 220 separately or together with detected/measured SSB. NE 210 may also allocate CSI-RS resources for each QCL. Furthermore, NE 210 may configure SI broadcast physical downlink control channel (PDCCH) resources related to each SSB to be transmitted over the access link.

Turning to repeater 220, repeater 220 may be configured with QCL identification. Repeater 220 may store a list of relay configurations containing periodicity and offset, duration, and QCL identification. Repeater 220 may then independently schedule relay occasions based on the configuration.

At 205, repeater 220 may generate a SSB according to the SSB configuration, and transmit the SSB over the access link. In some example embodiments, the generation of the SSB may be based on at least one of: information configured to generate at least one PSS; information configured to generate at least one SSS; PBCH information; at least one SSB sequence; at least one ID of a repeater configured to transmit the at least one SSB; a time and duration associated with transmitting the at least one SSB; at least one BWP ID; and at least one BWP.

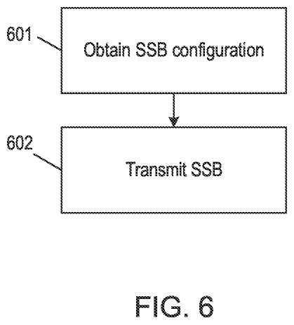

FIG. 6 illustrates an example of a flow diagram of a method that may be performed by a repeater; the corresponding apparatus of the repeater may be similar to NCR 820 illustrated in FIG. 8, according to certain example embodiments.

At 601, the method may include obtaining from a NE, similar to NE 810 illustrated in FIG. 8, a SSB configuration including at least a set of SSB IDs to be transmitted over an access link.

In some example embodiments, the SSB configuration may include at least a set of time-frequency resource allocation information. Furthermore, the SSB IDs of the at least a set of SSB IDs may differ from at least a set of other SSB IDs measured by the repeater, respectively. The method may also include receiving SIB messages according to the SSB configuration.

In various example embodiments, the SSB configuration may include at least one of: information configured to generate at least one PSS; information configured to generate at least one SSS; PBCH information; at least one SSB sequence (e.g., SSB transport block); at least one ID of a repeater configured to transmit the at least one SSB; a time and duration associated with transmitting the at least one SSB; at least one BWP ID; and/or at least one BWP. Furthermore, the at least one BWP ID may be associated with one of the at least a set of SSB IDs to be transmitted over the access link.

In certain example embodiments, the SSB configuration may be received over a BH link. Alternatively, the SSB configuration may be manually obtained from a local configuration of the repeater.

At 602, the method may further include transmitting at least one SSB over the access link according to the SSB configuration.

In some example embodiments, before obtaining the SSB configuration, the method may include transmitting at least one capability of the repeater to the NE, or detected/measured SSB information of the network entity.

In various example embodiments, the SSB configuration may be manually obtained/configured from a local configuration of the repeater. For example, the SSB configuration may be preconfigured by operator before it is initially used in a network. An operator may configure the SSB configuration manually.

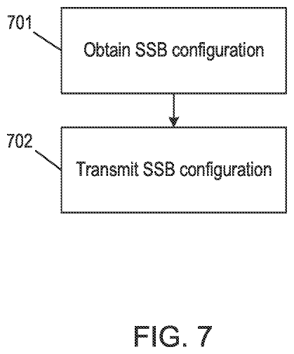

FIG. 7 illustrates an example of a flow diagram of a method that may be performed by a NE; the corresponding apparatus of the NE may be similar to NE 810 illustrated in FIG. 8, according to certain example embodiments.

At 701, the method may include obtaining a SSB configuration from a repeater, similar to NCR 820 illustrated in FIG. 8. The SSB configuration may include at least a set of SSB IDs to be transmitted over an access link of the repeater. The SSB configuration may include at least a set of time-frequency resources allocated for the SSB transmission over the access link of the repeater. The SSB IDs of the at least a set of SSB IDs may differ from at least a set of other SSB IDs detected/measured by the repeater.

In some example embodiments, the SSB configuration may include at least one of: information configured to generate at least one PSS; information configured to generate at least one SSS; PBCH information; at least one SSB sequence (e.g., SSB transport block); at least one ID of a repeater configured to transmit the at least one SSB; a time and duration associated with transmitting the at least one SSB; at least one BWP ID; and/or at least one bandwidth part. The at least one BWP ID may be associated with one of the at least a set of SSB IDs to be transmitted over the access link. The SSB configuration may be transmitted to the repeater over a BH link. The at least one capability of the apparatus may include at least one BWP part or BWP supported, as described above.

In certain example embodiments, before transmitting the SSB configuration, the method may include receiving at least one capability of the repeater, or detected/measured SSB information of the network entity.

In various example embodiments, the method may further include obtaining or determining the SSB configuration based on the detected/measured SSB information.

At 702, the method may further include transmitting, to the repeater, the SSB configuration.

FIG. 8 illustrates an example of a system according to some example embodiments. In various example embodiments, a system may include multiple devices, such as, for example, NE 810 and/or NCR 820.

NE 810 may be one or more of a base station (e.g., 3G UMTS NodeB, 4G LTE Evolved NodeB, or 5G NR Next Generation NodeB).

NE 810 may further include at least one gNB-centralized unit (CU), which may be associated with at least one gNB-distributed unit (DU). The at least one gNB-CU and the at least one gNB-DU may be in communication via at least one F1 interface, at least one Xₙ-C interface, and/or at least one NG interface via a 5^{th} generation core (5GC).

NE 810 and/or NCR 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 812 and 822. The memory may be fixed or removable. The memory may include computer program instructions or computer code contained therein. Memories 812 and 822 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 811 and 821, memories 812 and 822, and any subset thereof, may be configured to provide means corresponding to the various blocks of FIGS. 2-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications, or multiple antennas for multiple RATs. Other configurations of these devices, for example, may be provided. Transceivers 813 and 823 may be a transmitter, a receiver, both a transmitter and a receiver, or a unit or device that may be configured both for transmission and reception (i.e., panel).

Transceivers 813 and 823 may be coupled to one or more antennas or antenna ports configured to wirelessly transmit and/or receive communication signals. The antennas or antenna ports may be the same or different types. The antennas or antenna ports may be located in different positions of NE 810 and NCR 820. Transceivers 813 and 823 may allow NE 810 and NCR 820, respectively, to communicate with other devices that may be wired and/or wireless. Transceivers 813 and 823 may include processors, controllers, radios, sockets, plugs, buffers, circuits, and/or the like to form one or more communication channels to one or more radio frequency units.

The one or more transceivers may be integrated in an apparatus or a system, for example a cellular communication apparatus or system, a WLAN system, or a short ranging system for example Bluetooth system.

The memory and the computer program instructions may be configured, with the processor for the particular device, to cause a hardware apparatus, such as NE 810 and/or NCR 820, to perform any of the processes described above (i.e., FIGS. 2-7). Therefore, in certain example embodiments, a non-transitory computer-readable medium may be encoded with computer instructions that, when executed in hardware, perform a process such as one of the processes described herein. Alternatively, some example embodiments may be performed entirely in hardware.

In various example embodiments, an apparatus may include circuitry configured to perform any of the processes or functions illustrated in FIGS. 2-7. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to certain example embodiments, processors 811 and 821, and memories 812 and 822, may be included in or may form a part of processing circuitry or control circuitry. In addition, in some example embodiments, transceivers 813 and 823 may be included in or may form a part of transceiving circuitry.

In various example embodiments, an apparatus (e.g., NE 810 and/or NCR 820) may include means for performing a method, a process, or any of the variants discussed herein. Examples of the means may include one or more processors, memory, controllers, transmitters, receivers, and/or computer program code for causing the performance of the operations.

In certain example embodiments, NE 810 may be controlled by memory 812 and processor 811 to obtain a SSB configuration, and transmit the SSB configuration. The SSB configuration may include at least a set of SSB IDs to be transmitted over an access link of a repeater.

Some example embodiments may be directed to an apparatus that includes means for performing any of the methods described herein including, for example, means for obtaining a SSB configuration, and means for transmitting the SSB configuration. The SSB configuration may include at least a set of SSB IDs to be transmitted over an access link of a repeater.

In various example embodiments, NCR 820 may be controlled by memory 822 and processor 821 to obtain a SSB configuration including at least a set of SSB IDs to be transmitted over an access link, and transmit at least one SSB over the access link according to the SSB configuration.

Certain example embodiments may be directed to an apparatus that includes means for performing any of the methods described herein including, for example, means for obtaining a SSB configuration including at least a set of SSB IDs to be transmitted over an access link, and means for transmitting at least one SSB over the access link according to the SSB configuration.

The features, structures, or characteristics some example embodiments described throughout this specification may be combined in any suitable manner in one or more various example embodiments. For example, the usage of the phrases “various example embodiments,” “certain example embodiments,” “some example embodiments,” or other similar language throughout this specification refers to the fact that a particular feature, structure, or characteristic described in connection with an example embodiment may be included in at least one example embodiment. Thus, appearances of the phrases “in various example embodiments,” “in certain example embodiments,” “in some example embodiments,” or other similar language throughout this specification does not necessarily all refer to the same group of certain example embodiments, and the described features, structures, or characteristics may be combined in any suitable manner in one or more various example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

It should be noted that the embodiments in the present disclosure may be combined each other, in particular, some contents in one embodiment may be similar or combined with another embodiment but without elaboration in order to avoid redundant description. Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some example embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3^{rd} Generation Partnership Project
5G Fifth generation technology standard for broadband cellular networks
5GC 5^{th} Generation Core
6G 6^{th} Generation
AF Application Function
ASIC Application Specific Integrated Circuit
BH Backhaul
BS Base Station
BWP Bandwidth Part
CBSD Citizens Broadband Radio Service Device
CORESET Control Resource Set
CPU Central Processing Unit
CSI-RS Channel State Information Reference Signal
CU Centralized Unit
DCI Downlink Control Information
DL Downlink
DL-SCH Downlink Shared Channel
DMRS Demodulation Reference Signal
DU Distributed Unit
eMBB Enhanced Mobile Broadband
eNB Evolved NodeB
EMC Electromagnetic Compatibility
eOLLA Enhanced Outer Loop Link Adaptation
EPS Evolved Packet System
GHZ Gigahertz
gNB Next Generation NodeB
GPS Global Positioning System
HDD Hard Disk Drive
IAB-MT Integrated Access and Backhaul-Mobile Terminal
IoT Internet of Things
LTE Long-Term Evolution
LTE-A Long-Term Evolution Advanced
MEMS Micro Electrical Mechanical System
MIB Master Information Block
MIMO Multiple Input Multiple Output
MME Mobility Management Entity
mMTC Massive Machine Type Communication
MPDCCH Machine Type Communication Physical Downlink
Control Channel
Msg2 Msg2 in Random Access Procedure
Msg3 Msg3 in Random Access Procedure
Msg4 Msg4 in Random Access Procedure
NCR Network Controlled Repeater
NE Network Entity
NG Next Generation
NG-eNB Next Generation Evolved Node B
NG-RAN Next Generation Radio Access Network
NR New Radio
NR-U New Radio Unlicensed
PBCH Physical Broadcast Channel
PDA Personal Digital Assistance
PDCCH Physical Downlink Control Channel
PDSCH Physical Downlink Shared Channel
PSS Primary Synchronization Signal
PRACH Physical Random Access Channel
P-RNTI Paging Radio Network Temporary Identifier
PUCCH Physical Uplink Control Channel
PUSCH Physical Uplink Shared Channel
QCL Quasi Co-location
QoS Quality of Service
RACH Random Access Channel
RAM Random Access Memory
RAN Radio Access Network
RAR Random Access Response
RAT Radio Access Technology
RE Resource Element
RF Radio Frequency
RLC Radio Link Control
RNTI Radio Network Temporary Identifier
RO Random Access Channel Occasion
ROM Read-Only Memory
RRC Radio Resource Control
RS Reference Signal
RSRP Reference Signal Received Power
Rx Receiver
SIB System Information Block
SMF Session Management Function
SRS Sounding Reference Signal
SS Synchronization Signal
SSB Synchronization Signal Block
SSS Secondary Synchronization Signal
TDD Time Division Duplex
Tx Transmitter
UE User Equipment
UL Uplink
UL-SCH Uplink Shared Channel
UMTS Universal Mobile Telecommunications System
UPF User Plane Function
URLLC Ultra-Reliable and Low-Latency Communication
UTRAN Universal Mobile Telecommunications System
Terrestrial Radio Access Network
WLAN Wireless Local Area Network

1. An apparatus comprising:
at least one transceiver; and
at least one processor coupled to the at least one transceiver, wherein the apparatus is configured to:
obtain a synchronization signal block configuration comprising at least a set of synchronization signal block identifiers to be transmitted over an access link; and
transmit at least one synchronization signal block over the access link according to the synchronization signal block configuration.

2. The apparatus of claim 1, wherein the synchronization signal block configuration further comprises at least a set of time-frequency resource allocation information.

3. The apparatus of claim 1, wherein the synchronization signal block identifier of the at least a set of synchronization signal block identifiers differs from at least a set of other synchronization signal block identifiers detected or measured by the apparatus respectively.

4. The apparatus of claim 1, wherein the synchronization signal block configuration further comprises at least one of the following:
information configured to generate at least one primary synchronization signal;
information configured to generate at least one secondary synchronization signal;
physical broadcast channel information;
at least one synchronization signal block sequence;
at least one identifier of a repeater configured to transmit the at least one synchronization signal block;
a time and duration associated with transmitting the at least one synchronization signal block;
at least one bandwidth part identifier; or
at least one bandwidth part.

5. The apparatus of claim 1, wherein the at least one bandwidth part identifier is associated with one of the at least one set of synchronization signal block identifiers to be transmitted over the access link.

6. The apparatus of claim 1, wherein the synchronization signal block configuration is received from a network entity over a backhaul link.

7. The apparatus of claim 1, wherein the synchronization signal block configuration is manually obtained from a local configuration of the apparatus.

8. The apparatus of claim 1, wherein the at least one processor coupled to the at least one transceiver further causes the apparatus at least to:
transmit, to a network entity, at least one of the following:
at least one capability of the apparatus; or
detected or measured synchronization signal block information of the network entity.

9. The apparatus of claim 1, wherein the at least one capability of the apparatus comprises at least one bandwidth part or bandwidth supported.

10. The apparatus of claim 1, wherein the at least one processor coupled to the at least one transceiver further causes the apparatus at least to:
transmit, to the network entity, at least one of the following:
at least one beam identifier associated with each of the at least one synchronization signal blocks;
at least one reusability indicator associated with each of the at least one synchronization signal blocks; or
at least one channel state information reference signal beam identifier corresponding to each of the channel state information reference signal beams.

11. The apparatus of claim 4, wherein the physical broadcast channel information comprises system information.

12. An apparatus comprising:
at least one transceiver; and
at least one processor coupled to the at least one transceiver, wherein the apparatus is configured to:
obtain a synchronization signal block configuration, wherein the synchronization signal block configuration comprises at least a set of synchronization signal block identifiers to be transmitted over an access link of a repeater; and
transmit, to the repeater, the synchronization signal block configuration.

13-14. (canceled)

15. The apparatus of claim 12, wherein the synchronization signal block configuration further comprises at least one of the following:
information configured to generate at least one primary synchronization signal;
information configured to generate at least one secondary synchronization signal;
physical broadcast channel information;
at least one synchronization signal block sequence;
at least one identifier of a repeater configured to transmit the at least one synchronization signal block;
a time and duration associated with transmitting the at least one synchronization signal block;
at least one bandwidth part identifier; or
at least one bandwidth part.

16. The apparatus of claim 12, wherein the at least one bandwidth identifier is associated with one of the at least a set of synchronization signal block identifiers to be transmitted over the access link.

17. The apparatus of claim 12, wherein the synchronization signal block configuration is transmitted to the repeater over a backhaul link.

18. The apparatus of claim 12, wherein the at least one processor coupled to the at least one transceiver further causes the apparatus at least to:
receive, from the repeater device, at least one of the following:
at least one capability of the repeater; or
detected or measured synchronization signal block information of the repeater.

19. The apparatus of claim 12, wherein the at least one capability of the apparatus comprises at least one bandwidth part or bandwidth supported.

20. The apparatus of claim 12, wherein the at least one processor coupled to the at least one transceiver further causes the apparatus at least to:
obtain or determine the synchronization signal block configuration based on synchronization signal block reported from the repeater based on the detected or measured synchronization signal block information.

21. The apparatus of claim 12, wherein the at least one processor coupled to the at least one transceiver further causes the apparatus at least to:
receive, from the repeater device, at least one of the following:
at least one beam identifier associated with each of the at least one synchronization signal blocks;
at least one reusability indicator associated with each of the at least one synchronization signal blocks; or
at least one channel state information reference signal beam identifier corresponding to each of the channel state information reference signal beams.

22. The apparatus of claim 12, wherein the physical broadcast channel information comprises system information broadcast messages.

23-42. (canceled)
